(19) United States
(12) Patent Application Publication
(10) Pub. No.: US 2015/0129339 A1
(43) Pub. Date: May 14, 2015

(54) SERVICE COMPARTMENT FOR MACHINES

(71) Applicant: Caterpillar Inc., Peoria, IL (US)

(72) Inventors: Isabelle A. Lafont, Grenoble (FR); Julien S. Le Roux, Grenoble (FR); Alain F. Pizon, Revel (FR); Aurelien H. Bernard, Grenoble (FR)

(73) Assignee: Caterpillar Inc., Peoria, IL (US)

(21) Appl. No.: 14/603,392

(22) Filed: Jan. 23, 2015

(51) Int. Cl. B60R 3/02; B62D 25/24

(52) U.S. Cl. CPC B60R 3/02; B62D 25/24
USPC 180/69.24

(57) ABSTRACT

A service compartment for machines is disclosed. The service compartment includes a face portion, a door, and a step assembly mounted proximal to the door. The step assembly is switchable between a folded configuration and an extended configuration and includes a first base plate, a second base plate, and a stopper member. The first base plate has an attachment face attached to the face portion, and a support face. The second base plate has a first face and a second face and is pivotally attached to first base plate. The stopper member is attached to second base plate. In the folded configuration, the first face substantially overlaps the support face and the step assembly is disposed within the service compartment. In the extended configuration, the first face is substantially planar to the support face and the step assembly extends at least partially outwards of the service compartment.

### TECHNICAL FIELD

The present disclosure relates generally to a service compartment for a machine. More specifically, the present disclosure relates to a step assembly for the service compartment.

### BACKGROUND

Various machines, such as track-type loaders, are generally equipped with an engine compartment that houses various components of the machine. The components may include, but are not limited to, an engine, a transmission, and/or a drive assembly. During service and/or repair of the machine, these components are required to be accessed for maintenance purposes. However, it may be cumbersome for an operator to access those components while standing on the ground. Therefore, the engine compartment is equipped with a step assembly mounted proximal to an entry door of the engine compartment. The step assembly provides a means for the operator to stand on the step assembly and access those components of the machine.

In conventional engine compartments, the step assembly is positioned within the engine compartment and is kept relatively compact due to space constraints, which causes the operator to use the step assembly in a number of awkward positions. For example, the operator may need to stand in a toehold position on the step assembly, near an edge of the engine compartment, to access the components installed within the engine compartment. This may lead to uncomfortable and unsafe working conditions for the operator to service and/or repair the machine.

### SUMMARY OF THE INVENTION

Various aspects of the present disclosure are directed towards a service compartment for a machine. The service compartment has at least one door and a face portion. The service compartment includes a step assembly mounted proximal to the door of the service compartment. The step assembly is switchable between a folded configuration and an extended configuration. The step assembly includes a first base plate, a second base plate, and a stopper member. The first base plate has an attachment face and a support face. The attachment face is attached to the face portion of the machine. The second base plate is pivotally attached to the first base plate and is pivotally movable relative to the first base plate about a longitudinal axis. The second base plate has a first face and a second face. In the folded configuration, the first face of the second base plate substantially overlaps to the support face of the first base plate and the step assembly is disposed within the service compartment. In the extended configuration, the first face of the second base plate is positioned substantially planar to the support face of the first base plate and the step assembly extends at least partially outwards of the service compartment. The stopper member is attached to the second face of the second base plate and abuts against the face portion of the service compartment in the extended configuration. Thereby, the stopper member restricts the movement of the second base plate beyond a substantially planar position.

### BRIEF DESCRIPTION OF THE DRAWINGS

FIG. 1 is a perspective view of a machine that illustrates a service compartment of the machine, in accordance with the concepts of the present disclosure;

FIG. 2 is an enlarged view of the service compartment of the machine of FIG. 1 that illustrates a step assembly of the service compartment in a folded configuration, in accordance with the concepts of the present disclosure;

FIG. 3 is a further enlarged view of the service compartment of the machine that illustrates various components of the step assembly of FIG. 2, in accordance with the concepts of the present disclosure;

FIG. 4 is an enlarged view of the service compartment of the machine of FIG. 1 that illustrates the step assembly of the service compartment in an extended configuration, in accordance with the concepts of the present disclosure; and

FIG. 5 is a further enlarged view of the service compartment of the machine that illustrates various components of the step assembly of FIG. 4, in accordance with the concepts of the present disclosure.

### DETAILED DESCRIPTION

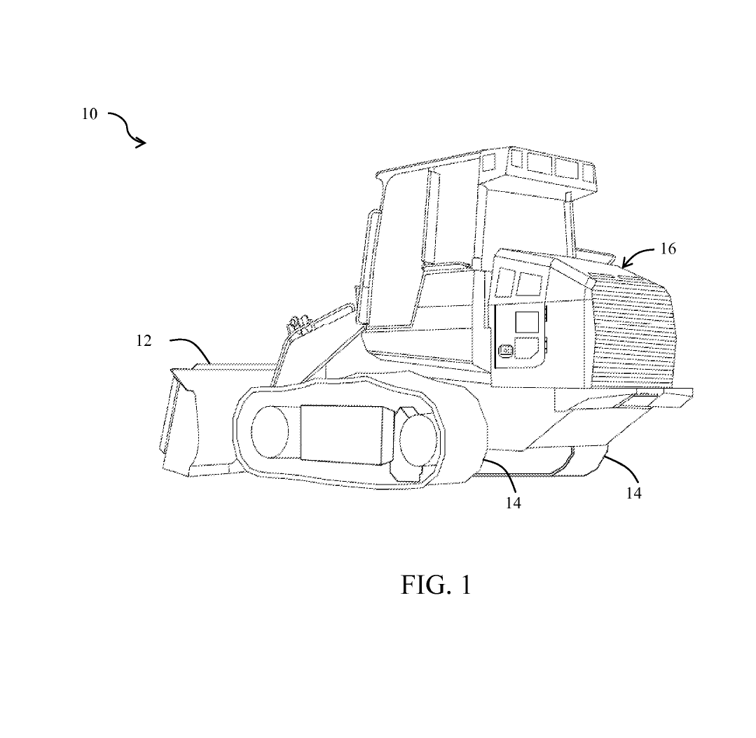

Referring to FIG. 1, there is shown a perspective view of a machine 10. The machine 10 may embody a construction machine, a forest machine, a marine machine, and/or any other similar machine. In the present disclosure, the machine 10 is depicted as a track-type loader. However, the concepts of the present disclosure may not be limited to the track-type loader. The machine 10 includes a loader 12 and a pair of tracks 14 and is adapted to load and transport construction material from one place to another. More specifically, the machine 10 carries construction material within the loader 12 and travels over the pair of tracks 14 to transport the construction material from one place to the other.

In addition, the machine 10 is equipped with an engine compartment 16 that houses various components of the machine 10, such as but not limited to, an engine, a transmission, and/or a drive assembly. For ease of reference, the engine compartment 16 may be referred to as a service compartment 16, interchangeably throughout this disclosure.

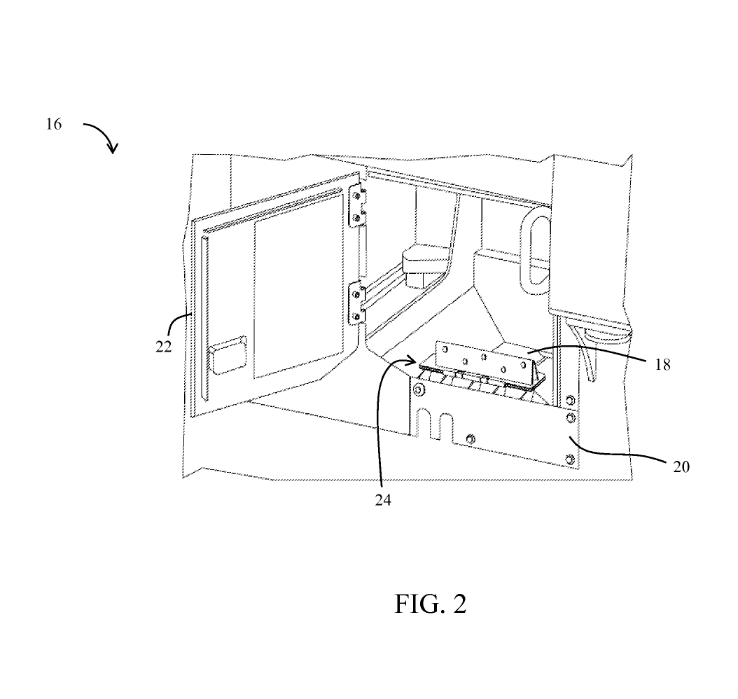

Referring to FIG. 2, there is shown the service compartment 16 of the machine 10. The service compartment 16 may be a closed chamber that includes a floor portion 18, a face portion 20, and at least one door 22. The floor portion 18, the face portion 20, and the door 22 define an interior of the service compartment 16, where several components of the machine 10 may be installed. As is previously mentioned, the components of the machine 10 may include components, such as but not limited to, an engine, a transmission, and/or a drive assembly. During service and/or repair of the machine 10, access to these components may be required by an operator. For ease in access to these components, the service compartment 16 is equipped with a step assembly 24, which is positioned proximal to the door 22 of the service compartment 16.

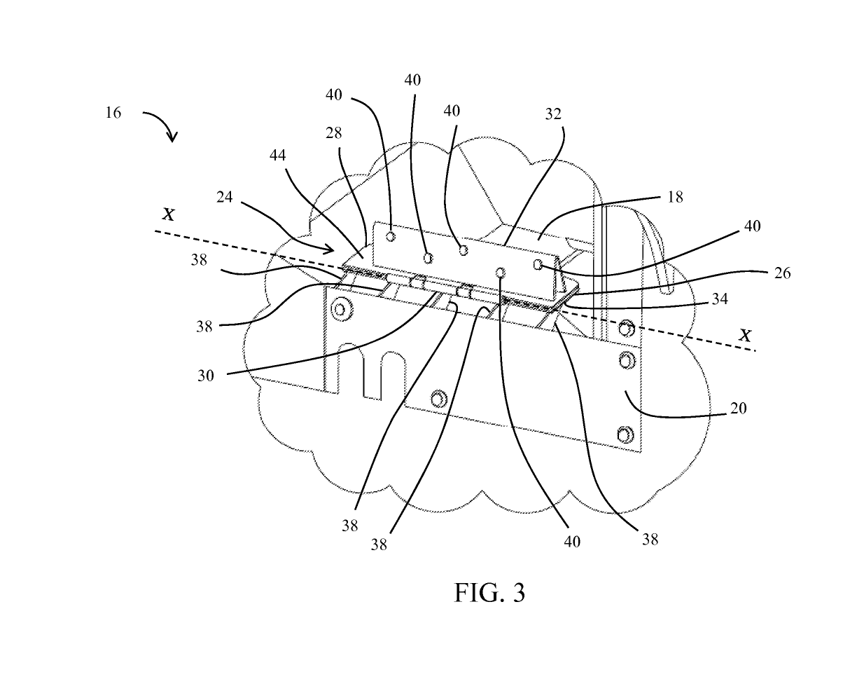

Referring to FIG. 3, there is shown the step assembly 24 of the service compartment 16. The step assembly 24 is mounted proximal to the door 22 of the service compartment 16 and includes a first base plate 26, a second base plate 28, a hinge member 30, and a stopper member 32.

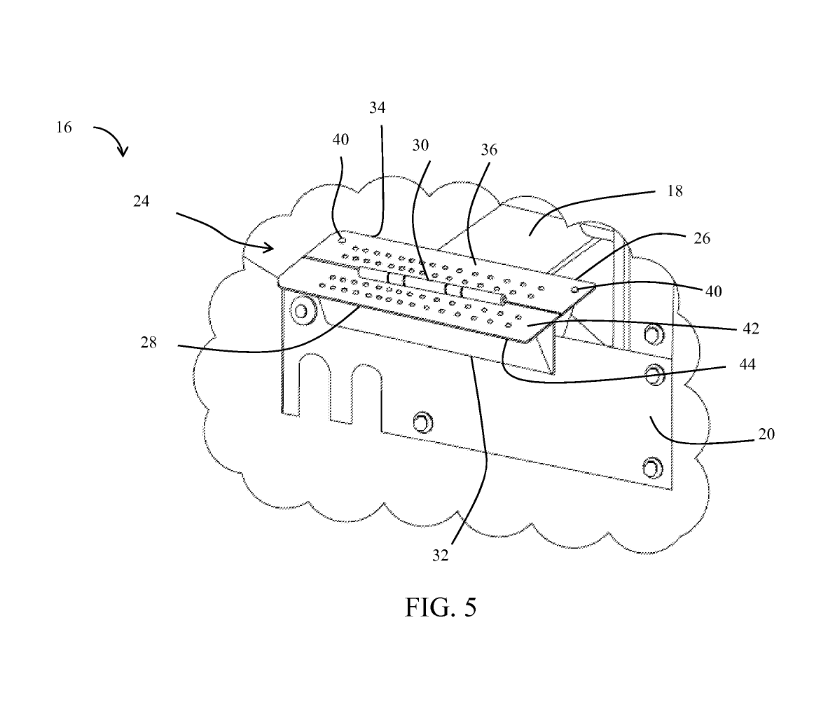

The first base plate 26 is positioned within the service compartment 16 and includes an attachment face 34 and a support face 36 (shown in FIG. 5). The attachment face 34 is fixedly attached to the face portion 20 of the service compartment 16 to mount the step assembly 24 onto the service compartment 16. Notably, the attachment face 34 is attached to the face portion 20 with use of a gusset and plate arrangement 38. Although, in the present disclosure, the first base plate 26 is attached to the face portion 20 with use of the gusset and plate arrangement 38, usage of any other similar known arrangement, such as but not limited to, a weld arrangement, a bolt arrangement, may also be envisioned. The stopper member 32 is equipped with dampers 40, to avoid metal to metal contact between the stopper member 32 and the face portion 20, in an extended configuration (as shown in FIG. 5).

The second base plate 28 includes a first face 42 (shown in FIG. 5) and a second face 44 and is pivotally attached to the first base plate 26 via the hinge member 30. The hinge member 30 facilitates a pivotal movement of the second base plate 28 relative to the first base plate 26 about a longitudinal axis X-X. Furthermore, the stopper member 32 is attached to the second face 44 of the second base plate 28. The stopper member 32 is adapted to restrict the pivotal movement of the second base plate 28, relative to the first base plate 26, beyond a substantially planar position. The specific structure and arrangement of the step assembly 24 enables it to be switchable between a folded configuration and an extended configuration.

In the folded configuration, as shown in FIG. 3, the first face 42 (as shown in FIG. 5) of the second base plate 28 substantially overlaps to the support face 36 (as shown in FIG. 5) of the first base plate 26. As the first base plate 26 is positioned within the service compartment 16, and the second base plate 28 substantially overlaps to the support face 36 of the first base plate 26, it may be contemplated that the entire step assembly 24 is positioned within the service compartment 16 in the folded configuration. More specifically, in the folded configuration, the step assembly 24 is stored within the service compartment 16.

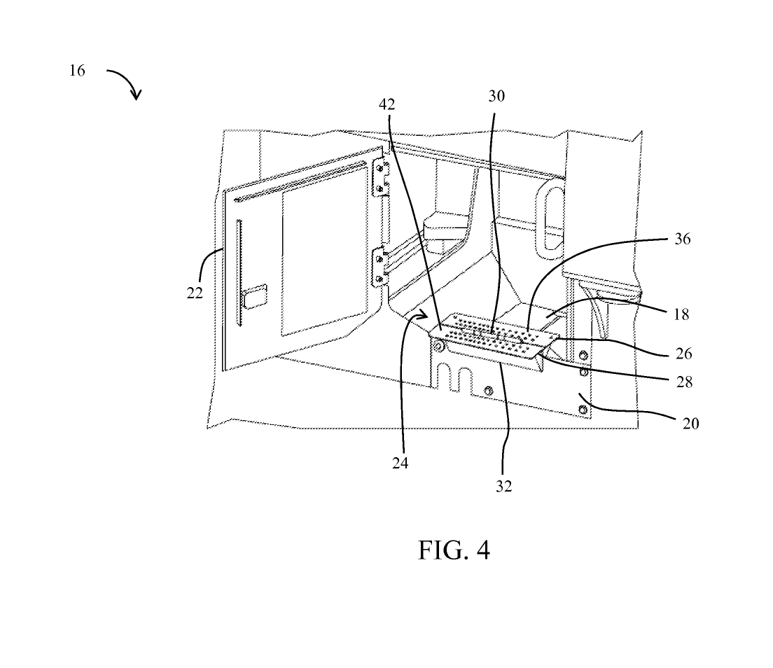

Referring to FIG. 4, there is shown the service compartment 16 of the machine 10 that illustrates the step assembly 24 in the extended configuration. Whenever required, the step assembly 24 may be manually adjusted to the extended configuration by pivotally rotating the second base plate 28 relative to the first base plate 26. The structure and arrangement of the step assembly 24 in the extended configuration is described in detail, in FIG. 5.

Referring to FIG. 5, there is shown the step assembly 24 in the extended configuration. In the extended configuration, the first face 42 of the second base plate 28 is positioned substantially planar to the support face 36 of the first base plate 26. Notably, the support face 36 is also equipped with dampers 40, to avoid metal to metal contact between the first base plate 26 and the second base plate 28, in the folded configuration (as shown in FIG. 3). Moreover, in the extended configuration, the second base plate 28 extends at least partially outward of the service compartment 16. More specifically, in the extended configuration, the second base plate 28 is in the substantially planar position relative to the first base plate 26, while the second base plate 28 extends at least partially outwards of the service compartment 16. Furthermore, in this position, the stopper member 32 abuts with the face portion 20 of the machine 10. As the stopper member 32 restricts the movement of the second base plate 28 relative to the first base plate 26 beyond the substantially planar position, the stopper member 32 maintains the extended configuration of the step assembly 24.

In an embodiment, the first face 42 of the second base plate 28 and the support face 36 of the first base plate 26 may have additional features such as a pattern of tread to provide friction to the operator's foot, during service.

### INDUSTRIAL APPLICABILITY

During normal operation, the machine 10 travels from one place to the other for transport of construction material. In such situations, the service compartment 16 is generally kept locked and the step assembly 24 of the machine 10 is required to be stored within the service compartment 16. Therefore, during normal operation of the machine 10, the step assembly 24 is installed in the folded configuration. As shown in FIG. 3, in the folded configuration of the step assembly 24, the first face 42 of the second base plate 28 substantially overlaps the support face 36 of the first base plate 26. Notably, as the first base plate 26 is installed within the service compartment 16 and the second base plate 28 substantially overlaps the first base plate 26. In this manner, the entire step assembly 24 is compactly stored within the service compartment 16.

Furthermore, during service and/or repair of the machine 10, the components installed within the service compartment 16 may need to be accessed by the operator. In those situations, the step assembly 24 is positioned in the extended configuration. Notably, the step assembly 24 is adjusted from the folded configuration to the extended configuration by pivotally rotating the second base plate 28 relative to the first base plate 26. As the second base plate 28 is rotated relative to the first base plate 26, the stopper member 32 restricts the pivotal movement of the second base plate 28 beyond the substantially planar position. When the second base plate 28 is adjusted to the substantially planar position, the step assembly 24 is adjusted to the extended configuration. In the extended configuration, as shown in FIG. 5, the first face 42 of the second base plate 28 is substantially planar to the support face 36 of the first base plate 26. Thereby, the support face 36 of the first base plate 26, and the first face 42 of the second base plate 28, form a platform for an operator to stand on the step assembly 24 to access the components installed within the service compartment 16. In the extended configuration, as the second base plate 28 extends at least partially outwards of the service compartment 16, the step assembly 24 provides a relatively wider and more comfortable platform for the operator to stand. This allows the operator to avoid awkward positions, such as but not limited to, a toehold position and/or a double step position. This results in relatively safer work conditions for the operator to service the machine 10.

It should be understood that the above description is intended for illustrative purposes only and is not intended to limit the scope of the present disclosure in any way. Those skilled in the art will appreciate that other aspects of the disclosure may be obtained from a study of the drawings, the disclosure, and the appended claim.

What is claimed is:

1. A service compartment for a machine, the service compartment having at least one door and a face portion, the service compartment comprising:
a step assembly mounted proximal to the at least one door of the service compartment, the step assembly being switchable between a folded configuration and an extended configuration, the step assembly including:
a first base plate having an attachment face and a support face, the attachment face being attached to the face portion of the machine;
a second base plate having a first face and a second face, the second base plate pivotally attached to the first base plate and pivotally movable relative to the first base plate about a longitudinal axis,
wherein, in the folded configuration, the first face of the second base plate substantially overlaps to the support face of the first base plate and the step assembly is disposed within the service compartment,
wherein, in the extended configuration, the first face of the second base plate is positioned substantially planar to the support face of the first base plate and the step assembly extends at least partially outwards of the service compartment; and
a stopper member attached to the second face of the second base plate, wherein the stopper member abuts against the face portion of the service compartment in the extended configuration, thereby restricting the movement of the second base plate beyond a substantially planar position.
